(19) United States
(12) Patent Application Publication
(10) Pub. No.: US 2004/0191362 A1
(43) Pub. Date: Sep. 30, 2004

(54) Synergistic improver mix

(76) Inventors: Dasappa Indrani, Mysore (IN); Pichan Prabhasankar, Mysore (IN); Jyotsna Rajiv, Mysore (IN); Gandham Venkateswara Rao, Mysore (IN)

Correspondence Address: HARNESS, DICKEY & PIERCE, P.L.C., P.O. BOX 828, BLOOMFIELD HILLS, MI, 48303, US

(21) Appl. No.: 10/400,041

(22) Filed: Mar. 26, 2003

(51) Int. Cl. A21D 2/00

(52) U.S. Cl. 426/20

(57) ABSTRACT

The present invention relates to a synergistic improver mix for use as an oxidant in bakery products and a process for preparing the same, the said improver mix comprising ascorbic acid, protease, xylanase and α-amylase in the ratio of 1 to 3:1 to 3:1 to 3:0.5 to 2.0 respectively.

### FIELD OF THE INVENTION

The present invention relates to an improver mix for bread and a process for making improved quality bread thereof.

### BACKGROUND AND PRIOR ART DESCRIPTION TO THE INVENTION

During the past several years, a great deal of attention has been given to potassium bromate the most effective and economical oxidant available to the baking industries. It was assumed for many years that during processing potassium bromate was converted into harmless bromide. But cereal researches in Japan found this to be untrue. The problem with bromate is that it has been shown to be a carcinogen. The best study on this subject was reported by Kurokawa and co-workers (Kurookawa Y., Hayashi Y., Mackawa A., Takahashi T., Kokubo T., and Odashima S., 1983. Corcinogenicity of potassium bromate administered orally to 344 rats. J. Natt Cancer institute 71:965). The 344 male and female rats were exposed to 250 and 500 ppm potassium bromate in drinking water for 110 weeks developed significant increase in the incidence of renal carcinomas. Other studies also produced similar results, which lead to listing of potassium bromate as a carcinogen. Most of the countries in EC, United Kingdom, Japan and New Zealand have banned the use of potassium bromate (Peter Ranum 1992. Potassium bromate in bread/baking. Cereal Food World 37 (3):253-258).

A recent risk analysis by the FDA identified 20 ppb as a safe level for residual potassium bromate. Studies have shown that potassium bromate added at 30 ppm for a one pound (454 g) loaf bread results in residual potassium bromate below 20 ppb when combined with proper formula specifications and process conditions (A. g. Giesecke and S. A. Taillie. 2000. Identifying factors affecting bromate residual levels in baked products: Preliminary studies. Cereal Food World 45(3), 111-120).

With regard to conclusions made on carcinogenicity of bromate, one could argue that the dose at which the carcinogenesis is observed is above that normally consumed in baked bread. When the risk benefit concept is considered, one could conclude that use of bromate is only a commercial versus a safety benefit. In this case, the risk could be considered to outweigh the benefits to the public (Dupuis B. 1997. Chemistry and Toxicology of Potassium Bromate. Cereal Foods World, 45(3), 171-181).

The baking industry faces another challenge-replacing bromate's functionality because of safety concerns regarding use of bromate and in consideration of existing and potential legislation that bans or limits its use (Allen W. G., 1999. Alternative oxidants as Dough Conditioners. Cereal Foods World, 44(9), 642-649).

Facing the possibilities of a ban on potassium bromate by the Food and Drug Administration, bakers and suppliers have put in a lot of effort to find acceptable substitutes with good results. (Thomas F. Spooner 1996. Potassium bromate reviews; be prepared for possible changes. Milling and Baking News. 30-32). Potassium bromate has been the oxidizing agent of choice because of its slow action, good oven spring and high tolerance. Bromate works on the gluten in flour to increase its strength and produce larger and more uniform finished products. It can be mixed into flour, added with yeast food to the sponge or added separately at mixing. No matter when it is added, bromate's slow action means it works primarily during proofing and baking. Most oxidizing agents act faster than bromate, making them less versatile and effective. As a result, most bromate replacers have to use a combination of additives to control the amount and timing of oxidation. Ascorbic acid is a natural oxidative agent that is probably the most widely used bromate replacer ingredient. It is label friendly but gives longer mix times, less oven spring, and firmer crumb than bromate. Enzymes are used with ascorbic acid to enhance oxidation and compensate for its shortcomings. No single enzyme has been found to replace the oxidative effect of bromate when enzymes are used, they are used as combination of oxidants (ascorbic acid, azodicarbonamide) with fungal amylases or blends of fungal proteases and fungal amylases (Kulp, K.1993. Enzymes as dough improvers. In: Advances in baking technology, ed. Kamel, B. S. and Stauffer, C. E. pp 152-178).

Bakery industry in India is the largest of the food industries with an annual turnover of about Rs. 5000 crores. It produces about 1.2 million tonnes of bread, 1.5 million tonnes of biscuits and 0.4 million tonnes of cakes and pastries (Vikas Singhal, 1999, Indian agricultural, Indian Economic Data Research Centre, pp 72-83). The major varieties of breads that are produced in India are plain bread, sweet bread, and fruit bread and milk bread. In south India, sweet bread prepared using 20-30% is a popular item and it is produced in every large, medium, small and family units and the total production of sweet bread is more than that of plain bread. The popularity of the sweet bread variety is because of its suitability for consumption without any adjuncts like butter and jam or even toasting. The literature survey indicated that whatever information available on bread includes bread prepared using 3-10% sugar in the formulation

Reference may be made to Haarasilta Sampa, Pullinen Timo, Vaisanen Seppo, Tammersalo-Karsten Ina U.S. Pat. No. 4,990,343 (1991), wherein a method is described for improving the properties of dough and the quality of bread by adding to the dough, dough ingredients, ingredient mixture or additive mixture an enzyme comprising hemicellulose and/or sulphydryl oxidase and glucose oxidase, the enzyme preparation being preferably used in combination with lecithin. The combination of enzyme preparation of the invention and lecithin can advantageously replace bromate conventionally used as a baking additive. The drawback here is that the invention uses enzyme preparation and lecithin to replace bromate and improve the quality of bread whereas in the present invention the enzymes used are different.

Reference may be made to Kim Yoon Ja Wo 9608972 (1996), wherein a method of preparing potassium bromate replacer is given. It comprises an ascorbic acid composition in an effective amount to replace an oxidising agent of potassium bromate. The potassium bromate replacer essentially comprises ascorbic acid, food acid, and/or phosphate. It is also an effective oxidant that produces completely oxidised dough needed in the production of high quality, yeast-leavened products using various methods of the bread making process. The drawback here is that the replacer is composed of chemicals and not enzymes.

Reference may be made to the patent of Destefanis Vincent GB 2264429 (1993), wherein compositions useful in improving dough and bread are disclosed. Compositions consist of calcium peroxide, iron salts and ascorbic acid which provide improver activity suitable for the replacement of known bromate improvers in bread dough by providing for reproducible, controllable conversion of ascorbic acid to dehydro-ascorbic acid. The drawback here is that the replacer is composed of calcium peroxide, iron salts and ascorbic acid and not combinations of enzymes as bromate replacer.

Reference may be made to Cottrell John and co-inventors, Patent WO 9832336 (1996) wherein enzyme-based bread improver which comprises a latent enzyme preparation active during and after proving but relatively inactive during mixing is disclosed. The drawback here is that the latent enzyme is used and not combination of enzymes.

Reference may be made to Roza Martinus and Maat Jan EP 0396162, B1, B2 (1990) wherein composition of bread improvers are disclosed. The cellulose bread improvers e.g., xylanase include an oxidase or peroxidase and the mixture can be incorporated in flour as an additive to dough for bread or other dough products e.g., puff pastry. The drawback here is that enzymes and amounts used are different for the present invention.

Reference may be made here to Si Joan Qi WO 9523515 (1995) wherein use of xylanase in baking is described. A method of improving properties of dough and/or a baked product made from dough by adding an enzyme preparation to the dough and/or to any ingredient of the dough and/or to any mixture of the dough ingredients in which method the enzyme preparation comprises a xylanase obtainable from a strain of the fungal species A.aculeatus. The drawback here is that the enzyme preparation comprises xylanase whereas the present invention relates to the use of enzymes to replace bromate and not xylanase only.

Reference may be made to Schuster Erwin D E U.S. Pat. No. 5,306,633 (1994) wherein the production of novel bacterial xylanase, obtained from Bacillus subtilis strain to improve the consistency and increase the volume of the bread and baked goods containing it is described. The drawback here is only use of xylanase.

Reference may be made here to Van Duynhoven Antonius Adrianu EP 0529712 (1993) wherein baking improvers comprising a specific enzyme, its use in flour and dough and a method for improving properties of dough and baked goods is described. The improving effects of enzyme beta-mannanase upon the quality of baked goods may partially or probably completely replace the conventional baking additives like sodium stearoyl lactylate and potassium bromate. Along with beta-mannanase other enzymes like xylanase, glucose oxidase, and/or alpha amylase of vegetable, animal or microbial origin may be used. The drawback here is that the enzymes used is different.

Reference may be made here to Liu Xiaozhen Patent CN 1246285 (2000) wherein an improving agent of wheat flour used for steamed bread contains such components as calcium-sodium stearoyl lactylate, monoglyceride stearate, fungus alpha amylase, xylanase, alkaline buffer, and starch diperser is described. It has high adaptability to different kinds of wheat flour and serves to improve fermentative quality of steamed bread. The drawback here is that the improving agent comprises emulsifiers, enzymes, buffer etc., and not enzymes to replace bromate. This product is steamed bread and not baked bread.

### OBJECTS OF THE PRESENT INVENTION

The main object of the present invention is to provide a synergistic improver mix to replace potassium bromate in bakery products.

Another object of the present invention relates to an improver mix to replace potassium bromate in the preparation of breads, buns or rolls or other yeast raised bakery products.

Another object of the present invention is to improve without addition of potassium bromate the quality of bread, using the improver mix of the invention.

Yet another object of present invention is to use ascorbic acid to replace the oxidative action of bromate and a combination of enzymes to make up for short comings of ascorbic acid.

Another object of the present invention relates to an improver mix comprising ascorbic acid, fungal α-amylase, protease and xylanase.

Another object of the present invention is to decrease the rate of crumb firming in bread during storage using the improver mix of the invention.

Still another object of the present invention is to provide a process for the production of an improver mix for the preparation of improved quality bread.

### DETAILED DESCRIPTION OF THE PRESENT INVENTION

Accordingly, the present invention provides a synergistic improver mix for use as an oxidant in bakery products, said improver mix comprising ascorbic acid, protease, xylanase and α-amylase in the ratio of 1 to 3:1 to 3:1 to 3:0.5 to 2 respectively.

In an embodiment of the present invention, the improver mix comprises ascorbic acid, protease, xylanase and α-amylase in the ratio of 1:1:1:0.5 respectively.

In another embodiment of the present invention, the enzymes are obtained from a natural source or a synthetic source.

In yet another embodiment of the present invention, the enzymes are obtained from a natural source.

In still another embodiment of the present invention, the enzymes are obtained from fungus.

In one more embodiment of the present invention, the xylanase enzyme is obtained from Aspergillus niger.

In one another embodiment of the present invention, the protease enzyme is obtained from Aspergillus oryzae.

In a further embodiment of the present invention, the α-amylase enzyme is obtained from Asperfillus oryzae.

In an embodiment of the present invention, the ascorbic acid is obtained from a natural source or a synthetic source.

In another embodiment of the present invention, the bakery product is selected from bread, bun or rolls.

In yet another embodiment of the present invention, the bakery product is bread.

The present invention also provides a bakery dough composition for preparing bakery products comprising 100 parts of wheat flour, 0.005-0.0150 parts of ascorbic acid, 0.0025-0.010 parts of α-amylase, 0.005-0.015 parts of protease and 0.005-0.015 parts of xylanase.

In an embodiment of the present invention, the bakery dough composition comprises 100 parts of wheat flour, 0.01 parts of ascorbic acid, 0.005 parts of α-amylase, 0.01 parts of protease and 0.01 parts of xylanase.

In another embodiment of the present invention, the enzymes are obtained from a natural source or a synthetic source.

In yet another embodiment of the present invention, the enzymes are obtained from a natural source.

In still another embodiment of the present invention, the enzymes are obtained from fungus.

In one more embodiment of the present invention, the xylanase enzyme is obtained from Aspergillus niger.

In one another embodiment of the present invention, the protease enzyme is obtained from Aspergillus oryzae.

In a further embodiment of the present invention, the α-amylase enzyme is obtained from Asperfillus oryzae.

In an embodiment of the present invention, the ascorbic acid is obtained from a natural source or a synthetic source.

In another embodiment of the present invention, the wheat flour used contains ash in the range of 0.45-0.5%, dry gluten in the range of 10-12%, protein content in the range of 10-12%, SDS-sedimentation value in the range of 55-65, falling number in the range of 400-500, damaged starch in the range of 8-10% and diastatic activity in the range of 250-350 mg of maltose/10 g flour.

In yet another embodiment of the present invention, the bakery product is selected from bread, bun or rolls.

In still another embodiment of the present invention, the bakery product is bread.

The present invention further provides a process preparing the dough composition, said process comprising step of blending 100 parts of wheat flour with 0.005-0.0150 parts of ascorbic acid, 0.0025-0.010 parts of α-amylase, 0.005-0.015 parts of protease, and 0.005-0.015 parts of xylanase.

In an embodiment of the present invention, said process comprising step of blending 100 parts of wheat flour with 0.01 parts of ascorbic acid, 0.005 parts of α-amylase, 0.01 parts of protease and 0.01 parts of xylanase.

In another embodiment of the present invention, the wheat flour used contains ash in the range of 0.45-0.5%, dry gluten in the range of 10-12%, protein content in the range of 10-12%, SDS-sedimentation value in the range of 55-65, falling number in the range of 400-500, damaged starch min the range of 8-10% and diastatic activity in the range of 250-350 mg of maltose/10 g flour.

In yet another embodiment of the present invention, the enzymes are obtained from a natural source or a synthetic source.

In still another embodiment of the present invention, the enzymes are obtained from a natural source.

In one more embodiment of the present invention, the enzymes are obtained from fungus.

In one another embodiment of the present invention, the xylanase enzyme is obtained from Aspergillus niger.

In a further embodiment of the present invention, the protease enzyme is obtained from Aspergillus oryzae.

In an embodiment of the present invention, the α-amylase enzyme is obtained from Asperfillus oryzae.

In another embodiment of the present invention, the enzymes are commercially available enzymes.

In yet another embodiment of the present invention, the commercial enzymes selected are xylanase (875×2 units/g) from aspergillus niger, the protease enzyme (30,000 HUT/g) from aspergillus oryzae, fumgal α-amlase enzyme (50,000 SKB units/g) from aspergillus oryzae.

In still another embodiment of the present invention, the ascorbic acid is obtained from a natural source or a synthetic source.

The present invention also provides a process for preparing bread using the dough composition, wherein said process comprises mixing of 100 parts of bakery dough composition of claim 21 with 1.5-2.5 parts of a fermenting agent, 10-30 parts of flavoring agent, 1-2 parts of fat and 60-64 parts of water to prepare a well developed dough, allowing the dough to ferment for 60-120 min and preparing bread by known methods.

In an embodiment of the present invention, the fermenting agent used is yeast.

In another embodiment of the present invention, the fermenting agent is compressed yeast.

In yet another embodiment of the present invention, the flavoring agent includes sugar and salt.

In still another embodiment of the present invention, 15 to 25 parts of sugar is added.

In one more embodiment of the present invention, 20 parts of sugar is added.

In one another embodiment of the present invention, 1 to 1.5 parts salt is added.

In a further embodiment of the present invention, the fat is obtained from a plant or animal source.

In an embodiment of the present invention, the fermentation of the dough is 90 minutes.

The present further relates to the bread obtained by following the aforesaid process, wherein the bread has quality characteristics such as appealing brown crust colour, creamish white crumb colour, fine uniform crumb grain with very thin cell walls and very soft texture with typical taste and reduced rate of crumb hardening during storage.

Accordingly the present invention relates to an improver mix to replace potassium bromate in bread making and a process thereof comprises:

Step 1. Preparation of Improver Mix

Blending of 100 parts of wheat flour with 0.0050-0.0150 parts of ascorbic acid (AA), 0.0025-0.010 parts of fungal α-amylase (FA), 0.005-0.0015 parts of protease (PRO) and 0.005-0.015 parts of xylanase (XY).

Step 2. Formulation for the Preparation of Bread.

| | |
|---|---|
| Improver mix | 100 |
| Yeast (Compressed) | 2.0 |
| Salt | 1.5 |
| Sugar | 20 |
| Fat | 1.0 |
| Calcium propionate | 0.3 |
| Glacial acetic acid | 0.1 |
| Water | 60 |

Step 3. Method of Preparation

a. Mixing of improver mix separated with yeast, salt, sugar (dissolved part of total water), fat and water for 4 min.

b. Fermenting the dough for a period of 90 min.

c. Remixing the dough for 2 min and rounding.

d. Fermenting the dough for 25 min.

e. Moulding the dough

f. Proofing the dough for 65 min.

g. Baking at 220° C. for 25 min.

h. Cooling for 2-3 hrs, packing.

i. Evaluating the bread for its physical and sensory characteristics

In an embodiment of present invention the wheat flour used may be such as having ash 0.45-0.5%, dry gluten 10-12%, protein content 10-12%, SDS -sedimentation value 55-65, falling number 400-500, damaged starch 8-10%, diastatic activity 250-350 mg of maltose/10 g flour.

In an embodiment of the present invention the enzymes selected may be commercially available xylanase (875×2 units/g) from aspergillus niger, the protease enzyme (30,000 HUT/g) from aspergillus oryzae and fungal α-amylase enzyme (50,000 SKB units/g) from aspergillus oryzae.

In yet another embodiment of the present invention, the fermentation time may be from 60 to 120 min.

In an another embodiment of the present invention the yeast selected may be compressed yeast.

In an another embodiment of the present invention the amount of sugar added for bread may be from 15-25%.

In one more embodiment of the present invention, the process for making improved quality sweet breads using the improver mix of the present invention, which comprises mixing of 100 parts of blend with 1.5-2.5 parts of compressed yeast, 15-25 parts of sugar, 1-1.5 parts of salt, 1-2 parts of fat and 60-64 parts of water to prepare a well developed dough, allows the dough to ferment for 60-120 min and the bread prepared by known methods.

In yet another embodiment of the present invention, the improved quality characteristics of bread may be having appealing brown crust colour, creamish white crumb colour, fine uniform crumb grain with very thin cell walls and very soft texture with typical taste and reduced rate of crumb hardening during storage.

In still yet an another embodiment of the present invention the weights of the ingredients used for the preparation of bread are

| Ingredients | Weight (kg) |
|---|---|
| Wheat flour | 100 |
| Ascorbic acid | 0.005-0.015 |
| Xylanase | 0.005-0.015 |
| Protease | 0.005-0.015 |
| Fungal α-amylase | 0.0025-0.01 |
| Yeast (Compressed) | 1.5-2.5 |
| Salt | 1.0-1.5 |
| Sugar | 15-25 |
| Fat | 0.5-1.5 |
| Calcium propionate | 0.2-0.4 |
| Glacial acetic acid | 0.005-0.15 |
| Water | 60-64 |

Preparation of bread with the following formulation

| Materials | Quantity (kg) | Dry matter |
|---|---|---|
| Wheat flour | 100.00 | 87.00 |
| Ascorbic acid | 0.01 | 0.01 |
| Xylanase | 0.01 | 0.01 |
| Protease | 0.01 | 0.01 |
| Fungal α-amylase | 0.005 | 0.005 |
| Yeast (compressed) | 2.0 | 0.5 |
| Salt | 1.5 | 1.5 |
| Sugar | 20 | 20 |
| Fat | 1.0 | 1.0 |
| Calcium propionate | 0.3 | 0.3 |
| Glacial acetic acid | 0.1 | 0.1 |
| Water | 64.0 | — |
| | | 110.44 |
| Add Moisture | | 56.89 |
| (34% moisture in sweet bread) | | 167.33 |
| Production loss | | |
| Production deficit | | −1.67 |
| | | 165.66 |

| | |
|---|---|
| Yield of standard loaves 400 g per 100 kg of flour | 414 Nos |

The different unit operations and conditions involved in preparation bread are given below in the following flow chart.

[image]

The following examples are given by way of illustrations and should not be construed to limit the scope of the present invention

### EXAMPLE 1

| Ingredients | (g) |
|---|---|
| Wheat flour | 100 |
| Potassium bromate | 0.0020 |

Blending of wheat flour with potassium bromate

### EXAMPLE 2

| Ingredients | (g) |
|---|---|
| Wheat flour | 100 |
| Ascorbic acid | 0.01 |

1. Blending of wheat flour with ascorbic acid

### EXAMPLE 3

| Ingredients | (g) |
|---|---|
| Wheat flour | 100 |
| Xylanase | 0.01 |

1. Blending of wheat flour with xylanase

### EXAMPLE 4

| Ingredients | (g) |
|---|---|
| Wheat flour | 100 |
| Protease | 0.01 |

1. Blending of wheat flour with protease

### EXAMPLE 5

| Ingredients | (g) |
|---|---|
| Wheat flour | 100 |
| Fungal α-amylase | 0.005 |

1. Blending of wheat flour with fungal α-amylase

### EXAMPLE 6

Effect of different additives on farinograph characteristics of wheat flour according to standard AACC method, 1995 (Method 54-21).

Farinograph experiments were conducted to find out the effect of additives on the farinograph characteristics of wheat flour. The results (Table 1) indicated a decrease in water absorption with fungal α-amylase, protease, an increase with ascorbic acid and no change with potassium bromate and xylanase. The dough development time decreased with fungal α-amylase, protease and increased with all other additives. The dough stability values when compared to control (13.9 min) decreased with fungal α-amylase (10.8 min), xylanase (12.7 min), protease (10 min), and increased with potassium bromate (14.6 min) and ascorbic acid (15.2 min) indicating an increase and decrease in the strength of the dough with potassium bromate, ascorbic acid and fungal α-amylase, xylanase, protease respectively.

TABLE 1
Effect of additives on farinograph characteristics of wheat flour

| | Water | Dough | | Mixing |
|---|---|---|---|---|
| Additives | absorption | development time | Stability | tolerance index |
| (%) | (%) | (%) | (min) | (BU) |
| Control | 61 | 5.3 | 13.9 | 14 |
| P B (0.0020) | 61 | 5.8 | 14.6 | 12 |
| AA (0.01) | 61.5 | 6.5 | 15.2 | 10 |
| XY (0.01) | 61 | 5.7 | 12.7 | 20 |
| PRO (0.01) | 60.5 | 3.8 | 10.0 | 30 |
| F A (0.005) | 60 | 4.0 | 10.8 | 25 |

PB: Potassium bromate,
AA: ascorbic acid,
XY: xylanase,
PRO: protease,
FA: fungal α-amylase

### EXAMPLE 7

Effect of different additives on extensograph characteristics of wheat flour according to standard AACC method 1995 (Method 54-21).

Extensograph experiments were conducted to find out the effect of additives on the extensograph characteristics of wheat flour. The results (Table 2) showed an increase in resistance to extension when compared to control (410 BU) with xylanase (425 BU), potassium bromate (450 BU), ascorbic acid (550 BU) and a decrease with fungal α-amylase (400 BU) and protease (380 BU). The values of extensibility increased from 158 mm to 162 mm with fungal α amylase, xylanase (168 mm), protease (170 mm) and decreased with potassium bromate (155 mm) and ascorbic acid (145 mm). The area values indicating the strength of the dough increased with xylanase, potassium bromate, ascorbic acid and decreased with fungal α-amylase and protease.

TABLE 2
Effect of additives on extensograph characteristics of wheat flour

| | Resistance to | | | |
|---|---|---|---|---|
| | extension, R | Extensibility, E | Ration figure, | Area |
| Additives (%) | (BU) | (mm) | R/E | (cm²) |
| Control | 410 | 158 | 2.6 | 118 |
| P B (0.0020) | 450 | 155 | 2.9 | 125 |
| AA (0.01) | 550 | 145 | 3.8 | 140 |
| X Y (0.01) | 425 | 168 | 2.5 | 136 |
| PRO (0.01) | 380 | 170 | 2.2 | 108 |
| F A (0.005) | 400 | 162 | 2.5 | 110 |

PB: potassium bromate,
AA: ascorbic acid,
XY: xylanase,
PRO: protease,
FA: fungal α-amylase.

### EXAMPLE 8

Preparation of bread with additives

| | |
|---|---|
| Wheat flour | 100 |
| Additives | |
| Ascorbic acid | 0.01 |
| or | |
| Xylanase | 0.01 |
| or | |
| Protease | 0.01 |
| or | |
| Fungal α-amylase | 0.005 |
| Yeast (Compressed) | 2.0 |
| Salt | 1.5 |
| Sugar | 20 |
| Fat | 1.0 |
| Calcium propionate | 0.3 |
| Glacial acetic acid | 0.1 |
| Water | 60 |

1. Mixing of wheat flour with additives (ascorbic acid or xylanase or protease or Fungal α-amylase) separately with yeast, salt, sugar (dissolved part of total water), fat and water for 4 min.

2. Fermenting the dough for a period of 90 min.

3. Remixing the dough for 2 min and rounding.

4. Fermenting the dough for 25 min.

5. Moulding the dough

6. Proofing the dough for 65 min.

7. Baking at 220° C. for 25 min.

8. Cooling for 2-3 hrs, packing.

9. Evaluating the bread for its physical and sensory characteristics.

Control bread and bread with additives were prepared and subjected to objective and sensory evaluation. The weight of control bread and breads prepared using different additives varied from 152.4 to 154.9 g and volume from 455 to 570 ml. The specific loaf volume of control bread was 2.94 ml/g and it increased to 3.52 to 3.74 ml/g for the breads prepared with different additives. Highest improvement in the specific loaf volume was brought about by xylanase followed by in the decreasing order with protease, fungal α-amylase, potassium bromate and ascorbic acid. The crust colour was dark brown, the shape of the crust was normal and the crumb colour was creamish white in all the breads. The control bread had medium fine crumb grain and the breads prepared using different additives possessed fine grain. The texture of bread prepared with different additives was softer than control as indicated by the lower crumb firmness values of 440-340 g when compared to 500 g of control. The eating quality was normal for all the additives. The above result indicated that bread with highest specific loaf volume and softer texture was produced by xylanase, followed in decreasing order by protease, fungal α-amylase, potassium bromate and ascorbic acid. The above results indicate that the overall bread making quality improvement brought about by xylanase or protease or fungal α-amylase was better than ascorbic acid and hence they could replace bromate in the preparation of bread.

TABLE 3
Effect of additives on the quality of bread

| | | | Specific | | Crumb | |
|---|---|---|---|---|---|---|
| Additives | Weight | Volume | volume | Crust | | Firmness** |
| (%) | (g) | (ml) | (ml/g) | Colour | Grain | (Force, g) |
| Control | 154.9 | 455 | 2.94 | Dark | Medium | 500 |
| | | | | Brown | fine | |
| PB | 153.2 | 540 | 3.52 | Dark | Fine | 420 |
| | | | | brown | | |
| AA | 153.2 | 520 | 3.39 | Dark | Fine | 440 |
| | | | | brown | | |
| XY | 152.4 | 570 | 3.74 | Dark | Fine | 340 |
| | | | | brown | | |
| PRO | 152.8 | 555 | 3.63 | Dark | Fine | 380 |
| | | | | brown | | |
| FA | 154.5 | 550 | 3.56 | Dark | Fine | 430 |
| | | | | brown | | |

*All the breads possessed normal crust shape, creamish white crumb colour and normal eating quality
**Force at 25% compression measured using Texture Analyser.
PB: Potassium bromate (0.0020%),
AA: Ascorbic acid (0.01%),
XY: Xylanase (0.01%),
PRO: Protease (0.01%),
FA: Fungal α-amylase (0.005%).

### EXAMPLE 9

Preparation of Combination I

| Ingredient | (g) |
|---|---|
| Wheat flour | 100 |
| Ascorbic acid | 0.01 |
| Xylanase | 0.01 |

1. Blending of wheat flour with ascorbic acid and xylanase.

### EXAMPLE 10

Preparation of Combination II

| Ingredient | (g) |
|---|---|
| Wheat flour | 100 |
| ascorbic acid | 0.01 |
| Xylanase | 0.01 |
| Protease | 0.01 |

1. Blending of wheat flour with ascorbic acid, xylanase and protease

### EXAMPLE 11

Preparation of Combination III

| Ingredient | (g) |
|---|---|
| Wheat flour | 100.000 |
| Ascorbic acid | 0.01 |
| Xylanase | 0.01 |
| Protease | 0.01 |
| Fungal α-amylase | 0.005 |

1. Blending of wheat flour with ascorbic acid, xylanase protease and fungal α-amylase

### EXAMPLE 12

Preparation of bread using combination of additives

| | |
|---|---|
| Control or potassium bromate | 100 |
| or combination (I or II or III)* | |
| Yeast (Compressed) | 2.0 |
| Salt | 1.5 |
| Sugar | 20 |
| Fat | 1.0 |
| Calcium propionate | 0.3 |
| Glacial acetic acid | 0.1 |
| Water | 64 |

*Combination I: Ascorbic acid (0.01%) + Xylanase (0.01%)
Combination II: Combination I + Protease (0.01%)
Combination III: Combination II + Fungal α-amylase (0.005%)

1. Mixing of separately control or potassium bromate or combination (I or II or III) with yeast, salt sugar (dispersed in part of total water), fat and water for 4 min.

2. Fermenting the dough for a period of 90 min.

3. Remixing the dough for 2 min and rounding.

4. Fermenting the dough for 25 min.

5. Moulding the dough

6. Proofing the dough for 65 min.

7. Baking at 220° C. for 25 min.

8. Cooling for 2-3 hrs and packing.

9. Evaluating the bread for its physical and sensory characteristics.

Experiments were conducted by preparing bread in order to find out the effect of different combination of additives on the quality of bread. Breads were evaluated for physical characteristics like weight and volume. The specific volume of bread was calculated by dividing values of the volume by the weight. The crumb firmness was measured according to AACC procedure 1995 (74-09) using Texture Analyser (Model Tahdi, Stable Micro Systems, UK) under the following conditions: sample thickness: 25 mm: load cell: 5 kg; aluminum plunger diameter: 25 mm and plunger speed: 100 mm/min. Crumb firmness which is a force at 25% compression was recorded for four samples and average of values was taken. Sensory evaluation of breads was carried out by a panel of six trained judges for crust colour, shape, crumb colour, grain, texture and eating quality.

Control bread and bread with different combination of additives were prepared and subjected to objective and sensory evaluation. The specific loaf volume of control bread was 2.94 ml/g, and it increased with potassium bromate (3.52 ml/g), combination I (3.59 ml/g), combination II (3.82 ml/g) and combination III (3.96 ml/g). All the breads possessed dark brown crust colour, normal crust shape and creamish white crumb colour. The crumb grain was medium fine for control whereas it improved to fine with potassium bromate, combination I and very fine with combinations II and III. The crumb firmness with of control bread was 500 g and it decreased with potassium bromate (420 g), combinations I (380 g), II (320 g) and III (305 g). The above results (FIG. 1) indicate that combination III could be used to replace potassium bromate in bread preparation.

TABLE 4
Effect of combination of additives on the quality* of bread

| | | | Specific | | Crumb | |
|---|---|---|---|---|---|---|
| | Weight | | volume | Crust | | Firmness* |
| Bread | (g) | Volume (ml) | (ml/g) | Color | Grain | (Force, g) |
| Control | 154.9 | 455 | 2.94 | Dark Brown | Medium fine | 500 |
| PB (0.0020%) | 153.2 | 540 | 3.52 | Dark brown | Fine | 420 |
| Combinations | | | | | | |
| I | 156.0 | 560 | 3.59 | Dark Brown | Fine | 380 |
| II | 153.0 | 585 | 3.82 | Dark Brown | Very Fine | 320 |
| III | 154.0 | 610 | 3.96 | Dark brown | Very Fine | 305 |

*All the breads possessed normal crust shape, creamish white crumb colour and normal eating quality
**Force at 25% compression measured using Texture Analyser.
PB: potassium bromate,
Combination I: Ascorbic acid (0.01%) + Xylanase (0.01%)
Combination II: Combination I + Protease (0.01%)
Combination III: Combination II + Fungal α-amylase (0.005%)

### EXPERIMENT 13

Effect of combination of additives on the storage characteristics of bread.

| Ingredients | g |
|---|---|
| Control or potassium bromate | 3000 |
| or combination (I or II or III)* | |
| Yeast (Compressed) | 60 |
| Salt | 45 |
| Sugar | 600 |
| Fat | 30 |
| Calcium propionate | 9 |
| Glacial acetic acid | 3 |
| Water | Variable |

*Combination I: Ascorbic acid (0.01%) + Xylanase (0.01%)
Combination II: Combination I + Protease (0.01%)
Combination III: Combination II + Fungal α-amylase (0.005%)

1. Mixing of control or potassium bromate or combinations (I or II or III) separately with yeast, salt and sugar (dissolved in part of the water) fat and water for 8 min.

2. Fermenting the dough for 90 min.

3. Remixing the dough.

4. Dividing the dough into 450 g and relaxing for 25 min.

5. Sheeting and moulding the dough.

6. Proofing the dough up to the rim.

7. Baking with lid closed at 220° C. for 25 min.

8. Cooling the breads for 2-3 hours.

9. Packing the breads in polypropylene pouches of 150-180 guage.

10. Storing the breads at room temperature till the appearance of mold growth.

11. Measuring the crumb firmness, which is a force at 25% compression at every alternative day.

Studies were carried out to find out the effect of combination of additives on the storage characteristics of bread. The results showed that with increase in storage period from 1 to 7 days the crumb firmness value of control bread was 460 g and it increased to 715 g at 7^{th} day of storage period. The bread with potassium bromate increased from 390 to 640 g, combination I (350 to 580 g), II (300 to 540 g) and III (280 to 510 g). The bread had mold free shelf life of 13 days.

TABLE 5
Effect of combination of additives on storage characteristics
of bread

| | |
|---|---|
| Crumb firmness (force, g) | Mold free |
| Storage (No. of days) | Shelf life |

| Bread | 1 | 2 | 5 | 7 | (Days) |
|---|---|---|---|---|---|
| Control | 460 | 530 | 600 | 715 | 13 |
| PB (0.0020) | 390 | 460 | 520 | 640 | 13 |
| Combinations | | | | | |
| I | 350 | 400 | 465 | 580 | 13 |
| II | 300 | 380 | 440 | 540 | 13 |
| III | 280 | 355 | 415 | 510 | 13 |

PB: potassium bromate,
Combination I: Ascorbic acid (0.01%) + Xylanase (0.01%)
Combination II: Combination I + Protease (0.01%)
Combination III: Combination II + Fungal α-amylase (0.005%)

The above results indicate that on any day of storage the crumb firmness values of sweet bread with bromate and with three different combinations were lower than control bread indicating softer nature of crumb with additives. However among different combinations tried the bread with combination I, II and III were better than bread with potassium bromate and combination III was best in producing bread with comparatively softer texture and maintaining it throughout storage of 7 days.

Based on the above results it could be concluded that combination III can be used to replace potassium bromate in the preparation of improved quality of bread and reduce when compared to potassium bromate the rate of crumb hardening during storage of bread.

1. A synergistic improver mix for use as an oxidant in bakery products, said improver mix comprising ascorbic acid, protease, xylanase and α amylase in the ratio of 1 to 3:1 to 3:1 to 3:0.5 to 2 respectively.

2. A synergistic improver mix as claimed in claim 1, wherein improver mix comprises ascorbic acid, protease, xylanase and α amylase in the ratio of 1:1:1:0.5 respectively.

3. A synergistic improver mix as claimed in claim 1, wherein the enzymes are obtained from a natural source or a synthetic source.

4. A synergistic improver mix as claimed in claim 1, wherein the enzymes are obtained from a natural source.

5. A synergistic improver mix as claimed in claim 1, wherein the enzymes are obtained from fungus.

6. A synergistic improver mix as claimed in claim 1, wherein the xylanase enzyme is obtained from Aspergillus niger.

7. A synergistic improver mix as claimed in claim 1, wherein the protease enzyme is obtained from Aspergillus oryzae.

8. A synergistic improver mix as claimed in claim 1, wherein the α amylase enzyme is obtained from Asperfillus oryzae.

9. A synergistic improver mix as claimed in claim 1, wherein the ascorbic acid is obtained from a natural source or a synthetic source.

10. A synergistic improver mix as claimed in claim 1, wherein the bakery product is bread.

11. A synergistic improver mix as claimed in claim 1, wherein the bakery product is sweat bread.

12. A bakery dough composition for preparing bakery products comprising 100 parts of wheat flour, 0.005-0.0150 parts of ascorbic acid, 0.0025-0.010 parts of α-amylase, 0.005-0.015 parts of protease and 0.005-0.015 parts of xylanase.

13. A bakery dough composition as claimed in claim 12, wherein the bakery dough composition comprises 100 parts of wheat flour, 0.01 parts of ascorbic acid, 0.005 parts of α-amylase, 0.01 parts of protease and 0.01 parts of xylanase.

14. A bakery dough composition as claimed in claim 12, wherein the enzymes are obtained from a natural source or a synthetic source.

15. A bakery dough composition as claimed in claim 12, wherein the enzymes are obtained from a natural source.

16. A bakery dough composition as claimed in claim 12, wherein the enzymes are obtained from fungus.

17. A bakery dough composition as claimed in claim 12, wherein the xylanase enzyme is obtained from Aspergillus niger.

18. A bakery dough composition as claimed in claim 12, wherein the protease enzyme is obtained from Aspergillus oryzae.

19. A bakery dough composition as claimed in claim 12, wherein the α amylase enzyme is obtained from Asperfillus oryzae.

20. A bakery dough composition as claimed in claim 12, wherein the ascorbic acid is obtained from a natural source or a synthetic source.

21. A bakery dough composition as claimed in claim 12, wherein the wheat flour used contains ash in the range of 0.45-0.5%, dry gluten in the range of 10-12%, protein content in the range of 10-12%, SDS-sedimentation value in the range of 55-65, falling number in the range of 400-500, damaged starch in the range of 8-10% and diastatic activity in the range of 250-350 mg of maltose/10 g flour.

22. A bakery dough composition as claimed in claim 12, wherein the bakery product is bread.

23. A bakery dough composition as claimed in claim 12, wherein the bakery product is sweat bread.

24. A process preparing the dough composition of claim 12, wherein said process comprising step of blending 100 parts of wheat flour with 0.005-0.0150 parts of ascorbic acid, 0.0025-0.010 parts of α-amylase, 0.005-0.015 parts of protease, and 0.005-0.015 parts of xylanase.

25. A process as claimed in claim 24, wherein said process comprising step of blending 100 parts of wheat flour with 0.01 parts of ascorbic acid, 0.005 parts of α-amylase, 0.01 parts of protease and 0.01 parts of xylanase.

26. A process as claimed in claim 24, wherein the wheat flour used contains ash in the range of 0.45-0.5%, dry gluten in the range of 10-12%, protein content in the range of 10-12%, SDS-sedimentation value in the range of 55-65, falling number in the range of 400-500, damaged starch min the range of 8-10% and diastatic activity in the range of 250-350 mg of maltose/10 g flour.

27. A process as claimed in claim 24, wherein the enzymes are obtained from a natural source or a synthetic source.

28. A process as claimed in claim 24, wherein the enzymes are obtained from a natural source.

29. A process as claimed in claim 24, wherein the enzymes are obtained from fungus.

30. A process as claimed in claim 33, wherein the xylanase enzyme is obtained from Aspergillus niger.

31. A process as claimed in claim 24, wherein the protease enzyme is obtained from Aspergillus oryzae.

32. A process as claimed in claim 24, wherein the α amylase enzyme is obtained from Asperfillus oryzae.

33. A process as claimed in claim 24, wherein the enzymes are commercially available enzymes.

34. A process as claimed in claim 24, wherein the commercial enzymes selected are xylanase (875×2 units/g) from aspergillus niger, the protease enzyme (30,000 HUT/g) from aspergillus oryzae, fumgal α-amlase enzyme (50,000 SKB units/g) from aspergillus oryzae.

35. A process as claimed in claim 24, wherein the ascorbic acid is obtained from a natural source or a synthetic source.

36. A process for preparing bread using the dough composition of claim 12, wherein said process comprises mixing of 100 parts of bakery dough composition of claim 21 with 1.5-2.5 parts of a fermenting agent, 10-30 parts of flavoring agent, 1-2 parts of fat and 60-64 parts of water to prepare a well developed dough, allowing the dough to ferment for 60-120 min and preparing bread by known methods.

37. A process for preparing bread as claimed in claim 36, wherein the fermenting agent used is yeast.

38. A process for preparing bread as claimed in claim 36, wherein the fermenting agent is compressed yeast.

39. A process for preparing bread as claimed in claim 36, wherein the flavoring agent includes sugar and salt.

40. A process for preparing bread as claimed in claim 36, wherein 15 to 25 parts of sugar is added.

41. A process for preparing bread as claimed in claim 36, wherein 20 parts of sugar is added.

42. A process for preparing bread as claimed in claim 36, wherein 1 to 1.5 parts salt is added.

43. A process for preparing bread as claimed in claim 36, wherein the fat is obtained from a plant or animal source.

44. A process for preparing bread as claimed in claim 36, wherein the fermentation of the dough is 90 minutes.

45. Bread obtained by following the process of claim 36.

46. Bread obtained by following the process of claim 36, wherein the bread has quality characteristics such as appealing brown crust colour, creamish white crumb colour, fine uniform crumb grain with very thin cell walls and very soft texture with typical taste and reduced rate of crumb hardening during storage.
